(19) United States
(12) Patent Application Publication
(10) Pub. No.: US 2022/0399617 A1
(43) Pub. Date: Dec. 15, 2022

(54) BATTERY PROVIDED WITH FIXING MEMBER

(71) Applicant: Prime Planet Energy & Solutions, Inc., Tokyo (JP)

(72) Inventors: Ryoichi WAKIMOTO, Kobe-shi (JP); Hiroaki IMANISHI, Kobe-shi (JP); Tsuyoshi KAWABATA, Himeji-shi (JP); Takenori KIMURA, Kakogawa-shi (JP)

(21) Appl. No.: 17/832,697

(22) Filed: Jun. 6, 2022

(30) Foreign Application Priority Data
Jun. 9, 2021 (JP) 2021-096885

(51) Int. Cl. H01M 50/533; H01M 10/04; H01M 50/103; H01M 50/534; H01M 50/54; H01M 50/543

(52) U.S. Cl. CPC H01M 50/533; H01M 10/0431; H01M 50/103; H01M 50/534; H01M 50/54; H01M 50/543

(57) ABSTRACT

A battery is provided in which a damage of the electrode tab group is suitably inhibited. Suitable one aspect of the battery herein disclosed is provided with a battery comprising an electrode body with a positive electrode and a negative electrode, and that is formed in a flat hexahedron shape having a pair of rectangular-shaped flat outer surfaces, and includes a battery case that accommodates them. Here, a fixing member is arranged from at least one flat outer surface among a pair of flat outer surfaces to a positive electrode electrical collector part or a negative electrode electrical collector part of the electrode body.

### CROSS REFERENCE TO RELATED APPLICATIONS

The present application claims the priority based on Japanese Patent Application No. 2021-096885 filed on Jun. 9, 2021, the entire contents of which are incorporated in the present specification by reference.

### BACKGROUND

The present disclosure relates to a battery provided with a fixing member.

### BACKGROUND ART

A battery such as a lithium ion secondary battery, generally includes an electrode body that is formed in a flat hexahedron shape and that has a positive electrode and a negative electrode (hereinafter, it might be simply referred to an “electrode”), includes an outer package that has an opening and that accommodates the electrode body, includes an opening-seal plate that seals the opening of the outer package, and includes a terminal that is electrically connected to the electrode inside the outer package and that extends to the outside of the outer package from the opening-seal plate. This type of battery is typical provided with an electrode tab group in which the electrode includes a plurality of tabs for electrical collection, and the electrode tab group includes a configuration that is connected to the terminal through an electrode electrical collector part. For example, Japanese Patent Application Publication No. 2017-50069 discloses a battery in which a positive electrode tab group is provided at one end part in the longitudinal direction of the electrode body and a negative electrode tab group is provided at the other end part. Then, it discloses a technique of connecting the above described electrode tab group to the electrode electrical collector part in a state that the electrode tab group is bent.

### SUMMARY

Anyway, at the time of using a battery, vibration, impact, or the like can be added to the battery from the outside. The tab consists of, for example, one part of the electrical collector body, is soft, and thus tends to easily suffer an effect of external force. Thus, if the electrode body is deviated from a predetermined disposed position by the external force (particularly, the external force added in the longitudinal direction of the electrode body) and thus a load is added to the electrode tab group, the possibility is caused that the electrode tab group is damaged. As the result, the fear is caused that the electrical connection of the electrode with the terminal becomes unstable or causes connection failure, and thus it is not preferable, in addition, according to the study of the present inventor, it was understood that, particularly in a case where the above described electrode tab group is connected to the electrode electrical collector part while being kept to be bent, the external force is concentrated on the above described bending portion and thus the electrode tab group tends to easily suffer a damage.

The present disclosure has been made in view of the above described circumstances, and the main purpose is to provide a battery that suitably inhibits the damage on the electrode tab group.

The present disclosure provides a battery which is provided with a battery comprising a first electrode body with a positive electrode and a negative electrode, and that is formed in a flat hexahedron shape having a pair of rectangular-shaped flat outer surfaces and includes a battery case that accommodates the above described first electrode body. The battery case includes an outer package that has a bottom wall, a pair of first side walls extending from the above described bottom wall and opposed to each other, a pair of second side walls extending from the above described bottom wall and opposed to each other, and an opening opposed to the above described bottom wall, and includes an opening-seal plate for sealing the above described opening. A positive electrode terminal and a negative electrode terminal are attached to the above described opening-seal plate, a positive electrode tab group including a plurality of positive electrode tabs is arranged at a side of one second side wall among the above described pair of second side walls, and a negative electrode tab group including a plurality of negative electrode tabs is arranged at a side of another second side wall among the above described pair of second side walls. The above described positive electrode tab group and the above described positive electrode terminal are electrically connected through a positive electrode electrical collector part, the above described positive electrode tab group is joined to the above described positive electrode electrical collector part in a state that the above described positive electrode tab group is bent to extend along the above described second side wall, the above described negative electrode tab group and the above described negative electrode terminal are electrically connected through a negative electrode electrical collector part, and the above described negative electrode tab group is joined to the above described negative electrode electrical collector part in a state that the above described negative electrode tab group is bent to extend along the above described second side wall. Here, a fixing member is arranged at a portion at least from one flat outer surface among the above described pair of flat outer surfaces to the above described positive electrode electrical collector part or the above described negative electrode electrical collector part.

By arranging the fixing member as described above, the electrode body is fixed with respect to the electrode electrical collector part fixed to the opening-seal plate and having the rigidity, and thus it is possible to suitably suppress the electrode body from moving in the longitudinal direction in the battery case. By this, it is possible to suppress the load on the electrode tab group, and thus it is possible to suitably inhibit the damage on the electrode tab group.

In one aspect of the battery herein disclosed, the above described positive electrode tab group is joined to a surface at a side of the above described first electrode body in the above described positive electrode electrical collector part, and the above described negative electrode tab group is joined to a surface at a side of the above described first electrode body in the above described negative electrode electrical collector part.

In one aspect of the battery herein disclosed, the above described positive electrode tab group is joined to the above described positive electrode electrical collector part in a state that the above described positive electrode tab group is gathered to a side of one flat outer surface among the above described pair of flat outer surfaces, and the above described negative electrode tab group is joined to the above described negative electrode electrical collector part in a state that the above described negative electrode tab group is gathered to a side of one flat outer surface among the above described pair of flat outer surfaces.

In one suitable aspect of the battery herein disclosed, the above described fixing member covers neither a join part of the above described positive electrode tab group and the positive electrode electrical collector part nor a join part of the above described negative electrode tab group and the above described negative electrode electrical collector part, in accordance with such a configuration, it is surely inhibit the electrode tab group from taking loads and thus taking damages which are caused by the interference of the fixing member and the electrode tab group, and thus it is preferable.

In one aspect of the battery herein disclosed, the above described positive electrode tab is configured with an aluminum or an aluminum alloy foil, and the above described negative electrode tab is configured with a copper or a copper alloy foil, Here, the above described fixing member is arranged at a portion at least from one flat outer surface among the above described pair of flat outer surfaces to the above described negative electrode electrical collector part but arranged at a portion from neither flat outer surface among the above described pair of flat outer surface to the above described positive electrode electrical collector part.

In one suitable aspect of the batter herein disclosed, the above described positive electrode electrical collector part includes a positive electrode first electrical collector part arranged between the above described opening-seal plate and the above described first electrode body, and a positive electrode second electrical collector part joined to the above described positive electrode tab group, and the above described negative electrode electrical collector part includes a negative electrode first electrical collector part arranged between the above described opening-seal plate and the above described first electrode body, and a negative electrode second electrical collector part joined to the negative electrode tab group. Here, the above described fixing member covers at least a join part of the above described positive electrode first electrical collector part and the above described positive electrode second electrical collector part, or a join part of the above described negative electrode first electrical collector part and the above described negative electrode second electrical collector part. As described above, by fixing the electrode body at a position closer to the opening-seal plate of the electrode electrical collector part, it is possible to suitably suppress the electrode body from moving in the longitudinal direction in the battery case.

In one aspect of the battery herein disclosed, the above described pair of flat outer surfaces each is configured with a separator, and a layer containing polyvinylidene fluoride is formed at the outermost surface of the above described separator.

In one aspect of the battery herein disclosed, a second electrode body whose configuration is the same as the above described first electrode body is further arranged in the above described battery case.

In one aspect of the battery according to such aspects, further one or a plurality of electrode bodies whose configurations are the same as the above described first electrode body are arranged between the above described first electrode body and the above described second electrode body.

In one suitable aspect of the battery according to such aspects, the above described first electrode body, an electrode body arranged between the above described first electrode body and the above described second electrode body, and the above described second electrode body are fixed. In accordance with such a configuration, it is possible to suitably suppress the electrode body arranged between the first electrode body and the second electrode body from moving in the longitudinal direction.

In one suitable aspect of the battery according to such aspects, it is not satisfied that the above described fixing member of the above described first electrode body and the above described fixing member of the above described second electrode body are arranged at any portion between the above described first electrode body, an electrode body arranged between the above described first electrode body and the above described second electrode body, and the above described second electrode body. In accordance with such a configuration, it is possible to make the integration thickness of the electrode body group be small, and thus it is possible to mitigate the pressure distribution of each electrode body. By this, it is possible to suitably suppress the nonuniform reaction of each electrode body.

In one suitable aspect of the battery according to such aspects, an auxiliary fixing member is further arranged at a portion from a flat outer surface opposed to the above described first side wall among the above described pair of flat outer surfaces of the above described first electrode body to a flat outer surface opposed to the above described first side wall among the above described pair of flat outer surfaces of the above described second electrode body. Here, the above described auxiliary fixing member is arranged at a portion other than the above described positive electrode electrical collector parts and the above described negative electrode electrical collector parts included by the above described first electrode body, an electrode body arranged between the above described first electrode body and the above described second electrode body, and the above described second electrode body. In accordance with such a configuration, it is possible to suitably suppress the electrode body arranged between the first electrode body and the second electrode body from moving in the longitudinal direction.

In one suitable aspect of the battery according to such aspects, insulation members are arranged between the above described first side wall opposed to the above described flat outer surface of the above described first electrode body among the above described pair of first side walls and the above described flat outer surface of the above described first electrode body, and between another first side wall among the above described pair of first side walls and the above described flat outer surface of the above described second electrode body in the above described battery case. Here, friction coefficients of the above described first electrode body, of an electrode body arranged between the above described first electrode body and the above described second electrode body, and of the above described second electrode body are larger than a friction coefficient of the above described insulation member and the above described flat outer surface of the above described first electrode body, and than a friction coefficient of the above described insulation member and the above described flat outer surface of the above described second electrode body. In accordance with such a configuration, it is possible to suitably suppress each electrode body from moving in the longitudinal direction.

In one suitable aspect of the battery according to such aspects, the above described insulation member is configured with a resin film, and friction coefficients of the above described first electrode body, of an electrode body arranged between the above described first electrode body and the above described second electrode body, and of the above described second electrode body are larger than a friction coefficient of the above described insulation member and the above described first side wall. In accordance with such a configuration, it is possible to suitably suppress each electrode body from moving in the longitudinal direction.

### BRIEF DESCRIPTION OF THE DRAWINGS

FIG. 1 is a perspective view that schematically shows a battery in accordance with one embodiment.

FIG. 2 is a schematic longitudinal cross section view that is shown along the II-II line of FIG. 1.

FIG. 3 is a schematic longitudinal cross section view that is shown along the III-III line of FIG. 1.

FIG. 4 is a schematic lateral cross section view that is shown along the IV-IV line of FIG. 1.

FIG. 5 is a schematic view that schematically shows an electrode body group attached to an opening-seal plate in accordance with one embodiment.

FIG. 6 is a perspective view that schematically shows an electrode body to which a positive electrode second electrical collector part and a negative electrode second electrical collector part are attached, in accordance with one embodiment.

FIG. 7 is a schematic view that shows a configuration of a wound electrode body rn accordance with one embodiment.

FIG. 8 is a partially enlarged cross sectional view that schematically shows the vicinity of a positive electrode terminal of FIG. 2.

FIG. 9 is a perspective view that schematically shows an opening-seal plate to which a positive electrode terminal, a negative electrode terminal, a positive electrode first connecting part, a negative electrode first connecting part, a positive electrode insulation member, and a negative electrode insulation member are attached, in accordance with one embodiment.

FIG. 10 is a perspective view in which the opening-seal plate of FIG. 9 is reversed.

FIG. 11 is a schematic cross sectional view that explains an insertion step of the battery in accordance with one embodiment.

FIG. 12 is a schematic view that schematically shows an electrode body group attached to an opening-seal plate, in accordance with another embodiment.

FIG. 13 is a schematic view that schematically shows an electrode body group attached to an opening-seal plate, in accordance with another embodiment.

FIG. 14 is a schematic view that schematically shows an electrode body group attached to an opening-seal plate, in accordance with another embodiment.

FIG. 15 is a schematic view that schematically shows an electrode body group attached to an opening-seal plate, in accordance with another embodiment.

### DETAILED DESCRIPTION OF THE PREFERRED EMBODIMENTS

Below, while referring to drawings, some suitable embodiments of the herein disclosed technique are explained. Additionally, the matters other than matters particularly mentioned in this specification, and required for practicing the present disclosure (for example, a general configuration and manufacturing process for the battery by which the present disclosure is not characterized) can be grasped as design matters of those skilled in the art based on the conventional technique in the present field. The present disclosure can be executed based on the contents disclosed in the present specification, and the technical common sense in the present field. In addition, the wording “A to B” representing a numerical value range means a content equal to or more than A and not more than B. In addition, it contains meanings “more than A” and “less than B”.

Additionally, in the present specification, the “battery” is a term widely denoting an electric storage device capable of taking out the electric energy, and is a concept containing the primary battery and the secondary battery. In addition, in the present specification, the “secondary battery” is a term widely denoting an electric storage device capable of repeatedly charging and discharging, and is a concept containing so called storage batteries (chemical batteries), such as a lithium ion secondary battery and a nickel hydrogen battery, and containing capacitors (physical batteries), such as an electric double layer capacitor.

<Battery 100>

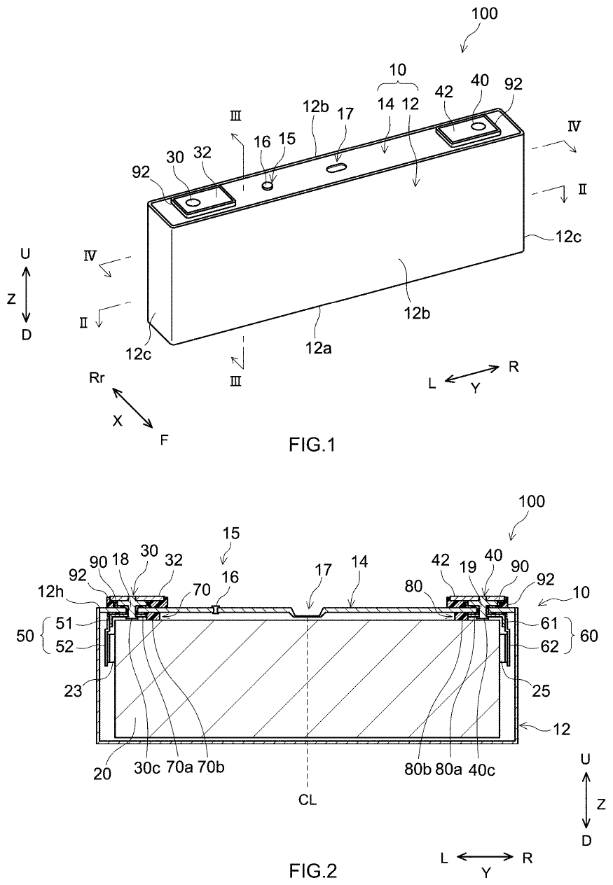

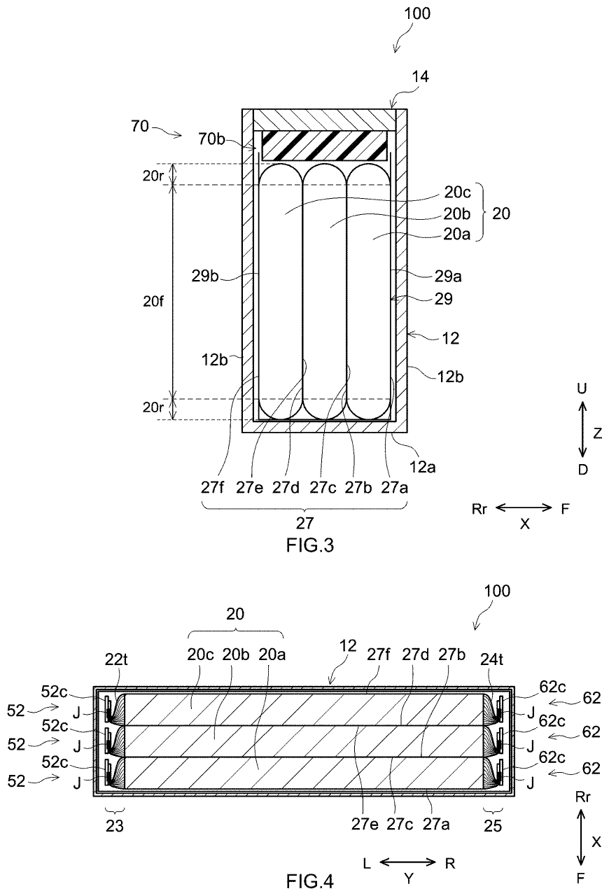

FIG. 1 is a perspective view of a battery 100. FIG. 2 is a schematic longitudinal cross section view that is shown along the line of FIG. 1. FIG. 3 is a schematic longitudinal cross section view that is shown along the III-III line of FIG. 1. FIG. 4 is a schematic lateral cross section view that is shown along the IV-IV line of FIG. 1. Additionally, in the explanation described below, the reference signs L, R, F, Rr. U, and D in drawings respectively represent left, right, front, rear, up, and down, and the reference signs X, Y, and Z in drawings respectively represent the short side direction, the long side direction orthogonal to the short side direction (it might be referred to as the longitudinal direction of the electrode body), and the vertical direction of the battery 100. However, these explains merely represent directions for convenience sake, and thus do not induce any restrictions on the disposed form of the battery 100.

As shown in FIG. 2, the battery 100 includes a battery case 10, an electrode body group 20, a positive electrode terminal 30, a negative electrode terminal 40, a positive electrode electrical collector part 50, a negative electrode electrical collector part 60, a positive electrode insulation member 70, and a negative electrode insulation member 80. Although not shown in drawings, the battery 100 here further includes an electrolyte. The battery 100 here is a lithium ion secondary battery. The battery 100 is characterized by including a fixing member 1 described later, and the other configurations might be similar to conventional configurations. The fixing member 1 is an example of the fixing member herein disclosed.

The battery case 10 is a housing that accommodates the electrode body group 20. The battery case 10 has an outer shape that here is a flat and bottomed rectangular parallelepiped shape (square shape). It is enough that the material of the battery case 10 is the same as the conventionally used material, which is not restricted particularly. 1t is preferable that the battery case 10 is made of metal, and it is more preferable that, for example, the battery case 10 is made of aluminum, aluminum alloy, iron, iron alloy, or the like. As shown in FIG. 2, the battery case 10 includes an outer package 12 that has an opening 12h, and includes an opening-seal plate (lid body) 14 that blocks the opening 12h.

As shown in FIG. 1, the outer package 12 includes a bottom wall 12a, includes a pair of long side walls 12b that extend from the bottom wall 12a and are opposed to each other, and includes a pair of short side walls 12c that extend from the bottom wall 12a and are opposed to each other. The bottom wall 12a is formed in an approximately rectangular shape. The bottom wall 12a is opposed to the opening 12h. The area of the short side wall 12c is smaller than the area of the long side wall 12b. The long side wall 12h and the short side wall 12c are respectively herein-disclosed examples of the first side wall and the second side wall. The opening-seal plate 14 is attached to the outer package 12 to block the opening 12h of the outer package 12. The opening-seal plate 14 is opposed to the bottom wall 12a of the outer package 12, The opening-seal plate 14 is formed to be an approximately rectangular shape in a plane view. The battery case 10 is integrated in which the opening-seal plate 14 is joined (for example, welded and joined) to the periphery of the opening 12h of the outer package 12. The battery case 10 is airtightly sealed (closed).

As shown in FIG. 2, the opening-seal plate 14 is provided with a liquid injection hole 15, a gas exhaust valve 17, and 2 terminal taking out holes 18, 19. The liquid injection hole 15 is for injecting the electrolyte after the opening-seal plate 14 is assembled to the outer package 12. The liquid injection hole 15 is sealed by a sealing member 16. The gas exhaust valve 17 is configured to be broken so as to exhaust the gas inside the battery case 10 to the outside when the pressure inside the battery case 10 becomes equal to or more than a predetermined value. The terminal taking out holes 18, 19 are respectively formed at both end parts of the opening-seal plate 14 in the long side direction Y The terminal taking out holes 18, 19 each penetrates the opening-seal plate 14 in a vertical direction Z. The terminal taking out holes 18, 19 respectively have an inner diameter capable of inserting the positive electrode terminal 30 before attached to the opening-seal plate 14 (before caulking process) and have an inner diameter capable of inserting the negative electrode terminal 40 before attached to the opening-seal plate 14 (before caulking process).

Each of the positive electrode terminal 30 and the negative electrode terminal 40 is fixed to the opening-seal plate 14. The positive electrode terminal 30 is arranged at one side of the opening-seal plate 14 in the long side direction Y (left side in FIG. 1 and FIG. 2). The negative electrode terminal 40 is arranged at the other side of the opening-seal plate 14 in the long side direction Y (right side in FIG. 1 and FIG. 2). As shown in FIG. 1, the positive electrode terminal 30 and the negative electrode terminal 40 are exposed to the outside surface of the opening-seal plate 14. As shown in FIG. 2, the positive electrode terminal 30 and the negative electrode terminal 40 respectively have the terminal taking out holes 18, 19 be inserted into and extended from the inside to the outside of the opening-seal plate 14. The positive electrode terminal 30 and the negative electrode terminal 40 are respectively caulked by the caulking process to the periphery portions surrounding the terminal taking out holes 18, 19 of the opening-seal plate 14, On the end parts (down end part of FIG. 2) at the outer package 12 side of the positive electrode terminal 30 and the negative electrode terminal 40, caulking parts 30c and 40c are respectively formed.

As shown in FIG. 2, the positive electrode terminal 30 is electrically connected to the positive electrode 22 of the electrode body group 20 through the positive electrode electrical collector part 50 at the inside of the outer package 12. The negative electrode terminal 40 is electrically connected to the negative electrode 24 of the electrode body group 20 through the negative electrode electrical collector part 60 at the inside of the outer package 12. The positive electrode terminal 30 is insulated from the opening-seal plate 14 by the positive electrode insulation member 70 and the gasket 90. The negative electrode terminal 40 is insulated from the opening-seal plate 14 by the negative electrode insulation member 80 and the gasket 90. The positive electrode terminal 30 and the negative electrode terminal 40 are examples of the herein-disclosed terminal.

It is preferable that the positive electrode terminal 30 is made of metal, for example, made of aluminum or aluminum alloy which is more preferable. It is preferable that the negative electrode terminal 40 is made of metal, for example, copper or copper alloy which is more preferable. The negative electrode terminal 40 might be configured with 2 conductive members which are joined and integrated. For example, the portion connected to the negative electrode electrical collector part 60 might be made of copper or copper alloy, and the portion exposed to the surface of the outside of the opening-seal plate 14 might be made of aluminum or aluminum alloy.

As shown in FIG. 1, a plate-shaped positive electrode outside conductive member 32 and a plate-shaped negative electrode outside conductive member 42 are attached to the surface of the outside of the opening-seal plate 14. The positive electrode outside conductive member 32 is electrically connected to the positive electrode terminal 30. The negative electrode outside conductive member 42 is electrically connected to the negative electrode terminal 40. The positive electrode outside conductive member 32 and the negative electrode outside conductive member 42 each is a member to which a bus bar is attached, when a plurality of batteries 100 are electrically connected. It is preferable that the positive electrode outside conductive member 32 and the negative electrode outside conductive member 42 each is made of metal, for example, made of aluminum or aluminum alloy which is more preferable. The positive electrode outside conductive member 32 and the negative electrode outside conductive member 42 each is insulated from the opening-seal plate 14 by an outside insulation member 92. However, neither the positive electrode outside conductive member 32 nor the negative electrode outside conductive member 42 is essential, and thus both might be omitted in another embodiment,

FIG. 5 is a perspective view that schematically shows the electrode body group 20 attached to the opening-seal plate 14, The electrode body group 20 here includes 3 electrode bodies 20a, 20b, 20c. The electrode bodies 20a, 20b, 20c each includes a pair of rectangular-shaped flat outer surfaces 27, and is formed in a flat hexahedron shape. The electrode bodies 20a, 20c are respectively examples of the herein disclosed first electrode body and second electrode body. However, the number of the electrode bodies arranged inside the one outer package 12 is not restricted particularly, and the number might be equal to or more than 2 (plural), or might be 1. The electrode body group 20 here is arranged at the inside of the outer package 12 in a state that the electrode body group is covered by an insulation member 29 configured with a resin film (see FIG. 3).

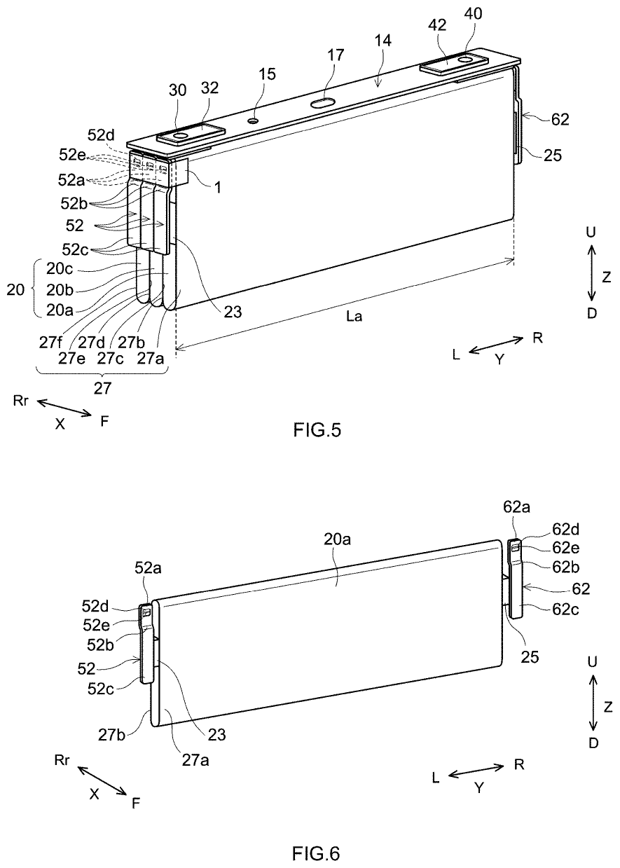

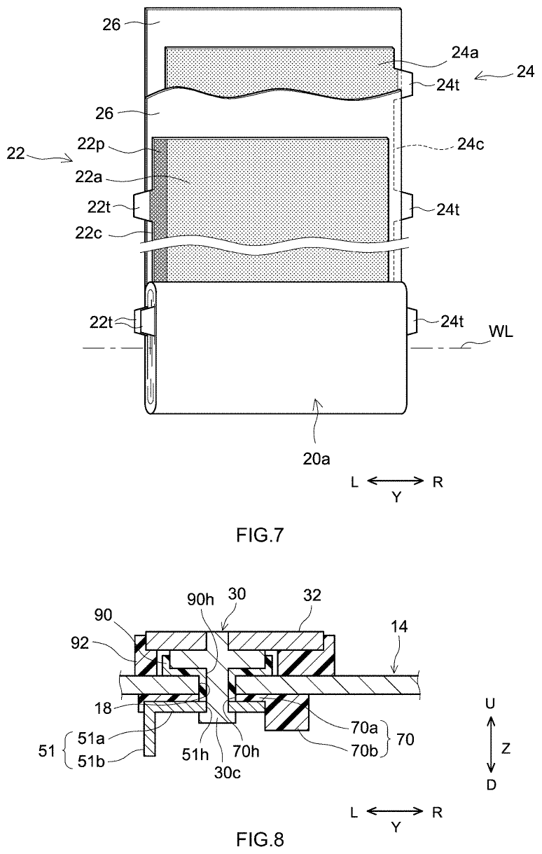

FIG. 6 is a perspective view that schematically shows the electrode body 20a. FIG. 7 is a schematic view that shows a configuration of the electrode body 20a. Additionally, while the electrode body 20a is explained below in detail as the example, the electrode bodies 20b, 20c can be also configured similarly. As shown in FIG. 7, the electrode body 20a includes a positive electrode 22 and a negative electrode 24, The electrode body 20a here has the strip-like shaped positive electrode 22 and the strip-like shaped negative electrode 24 be laminated through a strip-like shaped separator 26, and is a wound electrode body formed in a flat shape where the laminated resultant is wound around the wound axis WL as the center.

The electrode body 20a is arranged at the inside of the outer package 12 with the wound axis WL kept in a direction parallel to the long side direction Y. In other words, the electrode body 20a is arranged in a direction orthogonal to the short side wall 12c at the inside of the outer package 12 with the wound axis WL being in parallel to the bottom wall 12a. The end surface of the electrode body 20a (in other words, the lamination surface on which the positive electrode 22 and the negative electrode 24 are laminated, or end surface in the long side direction Y of FIG. 7) is opposed to the short side wall 12c.

As shown in FIG. 3, the electrode body 20a includes a pair of bent parts 20r that are opposed to the bottom wall 12a of the outer package 12 and to the opening-seal plate 14, and includes a flat part 20f that connects the pair of bent parts 20r and is opposed to the long side 12b of the outer package 12. However, the electrode body 20a might be a laminated electrode body in which a plurality of square shaped (typically, rectangular shaped) positive electrodes and a plurality of square shaped (typically, rectangular shaped) negative electrodes are stacked in a state that they are insulated.

As shown in FIG. 7, the positive electrode 22 includes a positive electrode electrical collector body 22c, and includes a positive electrode active material layer 22a and a positive electrode protective layer 22p that are fixed on at least one of surfaces of the positive electrode electrical collector body 22c. However, the positive electrode protective layer 22p is not essential, and it might be omitted in another embodiment. The positive electrode electrical collector body 22c is formed in a strip-like shape. The positive electrode electrical collector body 22c is made from an electric conductive metal, such as aluminum, aluminum alloy, nickel, and stainless steel. The positive electrode electrical collector body 22c here is a metal foil, particularly an aluminum foil. Although the width of the positive electrode electrical collector body 22c orthogonal to the long side direction Y (see FIG. 7) is not particularly restricted if the effect of the technique herein disclosed is implemented, it is preferable that the width is, for example, equal to or more than 0.5 mm.

At the one end part (left end part in FIG. 7) of the positive electrode electrical collector body 22c in the long side direction Y, a plurality of positive electrode tabs 22t are provided. The plurality of positive electrode tabs 22t each protrudes toward one side (left side in FIG. 7) in the long side direction Y. The plurality of positive electrode tabs 22t protrude in the long side direction Y more than the separator 26. The plurality of positive electrode tabs 22t are provided at the intervals (intermittently) along the longitudinal direction of the positive electrode 22. The plurality of positive electrode tabs 22t each is formed in a trapezoidal shape. The positive electrode tab 22t here is one part of the positive electrode electrical collector body 22c, and is configured with a metal foil (aluminum foil, aluminum alloy foil, or the like). The positive electrode tab 22t is a portion (electrical collector body exposed part) where neither the positive electrode active material layer 22a nor positive electrode protective layer 22p of the positive electrode electrical collector body 22c is formed. However, the positive electrode tab 22t might be a member different from the positive electrode electrical collector body 22c. In addition, the positive electrode tab 22t might be provided at the other end part in the long side direction Y (right end part of FIG. 7), or might be provided at the both end parts in the long side direction Y.

As shown in FIG. 7, a plurality of positive electrode tabs 22t are laminated at one end part in the long side direction Y (left end part of FIG. 7, in other words, one short-side-wall side among a pair of short side walls 12c (second side wall)), so as to configure a positive electrode tab group 23. The plurality of positive electrode tabs 22t are folded to be bent with the exterior side end extending along the short side wall 12c. The positive electrode tab group 23 is electrically connected to the positive electrode terminal 30 through the positive electrode electrical collector part 50. It is preferable that the plurality of positive electrode tabs 22t are folded, joined on a surface at the electrode body side of the positive electrode second electrical collector part 52 described later, and electrically connected to the positive electrode terminal 30. In addition, as shown in FIG. 4, it is preferable that the positive electrode tab group 23 is joined in a state of being gathered to one flat outer surface side among a pair of flat outer surfaces 27. The sizes of the plurality of positive electrode tabs 22t (the length in the long side direction Y and the width orthogonal to the long side direction Y, see FIG. 7) can be appropriately adjusted in consideration of the state of being connected to the positive electrode electrical collector part 50, for example, based on the formed position, or the like. Although the width of the positive electrode tab 22t orthogonal to the long side direction Y is not particularly restricted if the effects of the technique herein disclosed are implemented, it can be preferably 3 μm to 50 μm, more preferably 5 μm to 30 μm, or furthermore preferably 10 μm to 20 μm. The plurality of positive electrode tabs 22t here have different sizes from each other in order to align the exterior side ends when they are bent. The positive electrode tab group 23 is an example of the electrode tab group herein disclosed.

As shown in FIG. 7, the positive electrode active material layer 22a is provided in a strip-like shape along the longitudinal direction of the strip-like shaped positive electrode electrical collector body 22c. The positive electrode active material layer 22a includes a positive electrode active substance that can reversibly store and discharge the electric charge carrier (for example, lithium transition metal composite oxide, such as lithium nickel cobalt manganese composite oxide). In the case where the whole solid content of the positive electrode active material layer 22a is treated as 100 mass %, the positive electrode active substance might occupy approximately 80 mass % or more, typically 90 mass % or more, or for example, 95 mass % or more. The positive electrode active material layer 22a might include an arbitrary component other than the positive electrode active substance, for example, electrically conductive material, binder, various additive components, or the like. As for the electrically conductive material, it is possible to use a carbon material, such as acetylene black (AB). As the binder, it is possible to use, for example, polyvinylidene fluoride (PVdF), or the like.

As shown in FIG. 7, the positive electrode protective layer 22p is provided at the boundary portion of the positive electrode electrical collector body 22c and the positive electrode active material layer 22a in the long side direction Y. The positive electrode protective layer 22p here is provided at one end part (left end part in FIG. 7) of the positive electrode electrical collector body 22c in the long side direction Y. However, the positive electrode protective layer 22p might be provided at the both end parts in the long side direction Y. The positive electrode protective layer 22p is provided in a strip-like shape along the positive electrode active material layer 22a. The positive electrode protective layer 22p includes an inorganic filler (for example, alumina). In the case where the whole solid content of the positive electrode protective layer 22p is treated as 100 mass %, the inorganic filler might occupy approximately 50 mass % or more, typically 70 mass % or more, or for example, 80 mass % or more. The positive electrode protective layer 22p might include an arbitrary component other than the inorganic filler, for example, electrically conductive material, binder, various additive components, or the like. The electrically conductive material and the binder might be the same as the illustrated components capable of being included in the positive electrode active material layer 22a.

As shown in FIG. 7, the negative electrode 24 includes a negative electrode electrical collector body 24c, and a negative electrode active material layer 24a fixed on at least one of surfaces of the negative electrode electrical collector body 24c. The negative electrode electrical collector body 24c is formed in a strip-like shape. The negative electrode electrical collector body 24c is made from an electric conductive metal, such as copper, copper alloy, nickel, and stainless steel. The negative electrode electrical collector body 24c here is a metal foil, particularly a copper foil. Although the width of the negative electrode electrical collector body 24c orthogonal to the long side direction Y (see FIG. 7) is not particularly restricted if the effects of the technique herein disclosed is implemented, it is preferable that the width is, for example, equal to or more than 0.5 mm.

At the one end part (right end part in FIG. 7) of the negative electrode electrical collector body 24c in the long side direction Y, a plurality of negative electrode tabs 24t are provided. The plurality of negative electrode tabs 24t each protrudes toward one side (right side in FIG. 7) in the long side direction Y. The plurality of negative electrode tabs 24t protrude in the long side direction Y more than the separator 26. The plurality of negative electrode tabs 24t are provided at the intervals (intermittently) along the longitudinal direction of the negative electrode 24. The plurality of negative electrode tabs 24t each is formed in a trapezoidal shape. The negative electrode tab 24t here is one part of the negative electrode electrical collector body 24c, and is configured with a metal foil (copper foil, copper alloy, or the like). The negative electrode tab 24t here is a portion where the negative electrode active material layer 24a of the negative electrode electrical collector body 24c is not formed (electrical collector body exposed part). However, the negative electrode tab 241 might be a member different from the negative electrode electrical collector body 24c. In addition, the negative electrode tab 241 might be provided at the other end part in the long side direction Y (left end part in FIG. 7), or might be provided at both end parts in the long side direction Y.

As shown in FIG. 7, a plurality of negative electrode tabs 24t are laminated at one end part in the long side direction Y (right end part in FIG. 7, in other words, the side of the other short-side-wall among the pair of short side walls 12c (second side wall)), so as to configure a negative electrode tab group 25. The plurality of negative electrode tabs 24t are folded to be bent with the exterior side end extending along the short side wall 12c. The negative electrode tab group 25 is electrically connected to the negative electrode terminal 40 through the negative electrode electrical collector part 60. It is preferable that the plurality of negative electrode tabs 24t are folded, joined to a surface at the electrode body side of the negative electrode second electrical collector part 62 described later, and electrically connected to the negative electrode terminal 40. In addition, as shown in FIG. 4, it is preferable that the negative electrode tab group 25 is joined in a state of being gathered to a side of one flat outer surface among the pair of flat outer surfaces 27. The sizes of the plurality of negative electrode tabs 24t (the length in the long side direction Y and the width orthogonal to the long side direction Y see FIG. 7) can be appropriately adjusted in consideration of the state of being connected to the negative electrode electrical collector part 60, for example, based on the formed position, or the like. Although the width of the negative electrode tab 24t orthogonal to the long side direction Y is not particularly restricted if the effects of the technique herein disclosed are implemented, it can be preferably 3 μm to 50 μm, more preferably 5 μm to 30 μm, or furthermore preferably 5 μm to 20 μm. The plurality of negative electrode tabs 241 here have different sizes from each other in order to align the exterior side ends when they are bent. The negative electrode tab group 25 is an example of the electrode tab group herein disclosed.

The negative electrode active material layer 24a is provided in a strip-like shape along the longitudinal direction of the strip-like shaped negative electrode electrical collector body 24c. The negative electrode active material layer 24a includes a negative electrode active substance that can reversibly store and discharge the electric charge carrier (for example, carbon material, such as graphite). In the case where the whole solid content of the negative electrode active material layer 24a is treated as 100 mass %, the negative electrode active substance might occupy approximately 80 mass % or more, typically 90 mass % or more, or for example, 95 mass % or more. The negative electrode active material layer 24a might include an arbitrary component other than the negative electrode active substance, for example, binder, dispersing agent, various additive components, or the like. As the binder, it is possible to use rubbers, for example, styrene butadiene rubber (SBR), or the like. As the dispersing agent, it is possible to use celluloses, for example, carboxy methyl cellulose (CMC), or the like.

The separator 26 is a member that insulates the positive electrode active material layer 22a of the positive electrode 22 and the negative electrode active material layer 24a of the negative electrode 24. As for the separator 26, a porous resin sheet is suitable that is made from polyolefin resin, such as polyethylene (PE), and polypropylene (PP). Additionally, on the surface of the separator 26, a heat resistance layer (HRL) including an inorganic filler might be provided. As the inorganic filler, it is possible to use, for example, alumina, boehmite, aluminum hydroxide, Titania, or the like.

It is enough that the electrolyte is similar to the conventional one, and it is not particularly restricted. The electrolyte is, for example, a nonaqueous electrolyte containing a nonaqueous type solvent and a supporting salt. The nonaqueous type solvent includes carbonates, for example, ethylene carbonate, dimethyl carbonate, ethyl methyl carbonate, or the like. The supporting salt is, for example, a fluorine-containing lithium salt, such as LiPF₆. However, the electrolyte might be in a solid form (solid electrolyte) and be integrated with the electrode body group 20.

The positive electrode electrical collector part 50 configures a conduction passage that electrically connects the positive electrode tab group 23 consisted of the plurality of positive electrode tabs 221 and the positive electrode terminal 30, As shown in FIG. 2, the positive electrode electrical collector part 50 includes a positive electrode first electrical collector part 51 which is arranged between the opening-seal plate 14 and the electrode body 20a, and includes a positive electrode second electrical collector part 52 to which the positive electrode tab group 23 is joined. The positive electrode first electrical collector part 51 and the positive electrode second electrical collector part 52 might be made from the same metal species as the positive electrode electrical collector body 22c, for example, an electric conductive metal of aluminum, aluminum alloy, nickel, stainless steel, or the like.

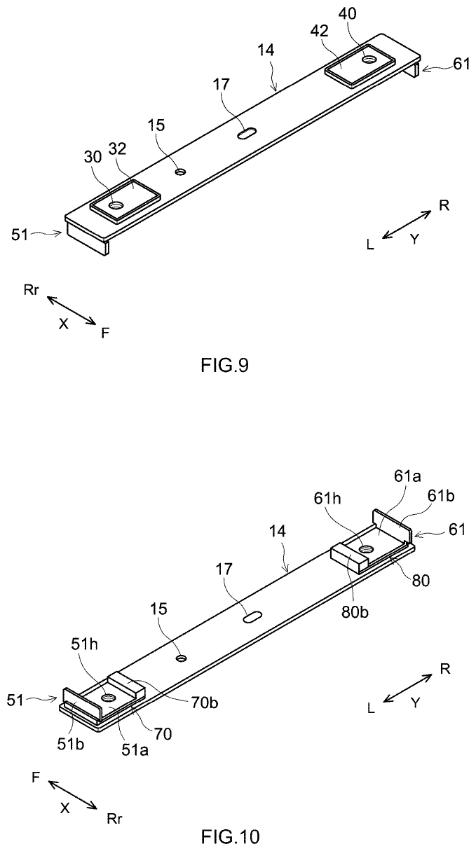

FIG. 8 is a partially enlarged cross sectional view that schematically shows the vicinity of the positive electrode terminal 30 of FIG. 2. FIG. 9 is a perspective view that schematically shows the opening-seal plate 14. FIG. 10 is a perspective view in which the opening-seal plate of FIG. 9 is reversed. FIG. 10 shows a surface at the side of outer package 12 (inner side) of the opening-seal plate 14. As shown in FIG. 8 to FIG. 10, the positive electrode first electrical collector part 51 is attached to the inner side surface of the opening-seal plate 14. The positive electrode first electrical collector part 51 is an example of the electrical collector part herein disclosed. The positive electrode first electrical collector part 51 includes a first area 51a and a second area 51b. The positive electrode first electrical collector part 51 might be configured, for example, by bending one member with a pressing process, or the like, or might be configured by integrating a plurality of members with welding and joining, or the like. The positive electrode first electrical collector part 51 here is fixed to the opening-seal plate 14 by a caulking process.

The first area 51a is a portion arranged between the opening-seal plate 14 and the electrode body group 20. The first area 51a extends along the long side direction Y. The first area 51a expands horizontally along the inner side surface of the opening-seal plate 14. Between the opening-seal plate 14 and the first area 51a, the positive electrode insulation member 70 is arranged. The first area 51a is insulated from the opening-seal plate 14 by the positive electrode insulation member 70. The first area 51a here is electrically connected to the positive electrode terminal 30 by the caulking process. In the first area 51a, at the position corresponding to the terminal taking out hole 18 of the opening-seal plate 14, a penetration hole 51h being penetrated in the vertical direction Z is formed. The second area 51b is a portion arranged between the short side wall 12c of the outer package 12 and the electrode body group 20. The second area 51b extends from the one side end (left end in FIG. 8) in the long side direction Y of the first area 51a to the short side wall 12c of the outer package 12. The second area 51b extends along the vertical direction Z.

The positive electrode second electrical collector part 52 extends along the short side wall 12c of the outer package 12. As shown in FIG. 6, the positive electrode second electrical collector part 52 includes an electrical collector plate connecting part 52a, an inclined part 52b, and a tab join part 52c. The electrical collector plate connecting part 52a is a portion electrically connected to the positive electrode first electrical collector part 51. The electrical collector plate connecting part 52a extends along the vertical direction Z. The electrical collector plate connecting part 52a is arranged in an approximately perpendicular direction to the wound axis WL of the electrode body 20a, 20b, 20c, On the electrical collector plate connecting part 52a, a recessed part 52d is provided whose thickness is thinner than the periphery. On the recessed part 52d, a penetration hole 52e is provided that is penetrated in the short side direction X. On the penetration hole 52e, a join part is formed that is joined to the positive electrode first electrical collector part 51. The join part is a welded and joined part that is formed, for example, by welding, such as ultrasonic welding, resistance welding, and laser welding. On the positive electrode second electrical collector part 52, a fuse might be provided.

The tab join part 52c is attached to the positive electrode tab group 23, and is a portion electrically connected to the plurality of positive electrode tabs 22t. As shown in FIG. 5, the tab join part 52c extends along the vertical direction Z. The tab join part 52c is arranged in an approximately perpendicular direction to the wound axis WL of the electrode body 20a, 20b, 20c. The surface of the tab join part 52c connected to the plurality of positive electrode tabs 22t is arranged in an approximately parallel direction to the short side wall 12c of the outer package 12. As shown in FIG. 4, on the tab join part 52c, a join part J is formed that is joined to the positive electrode tab group 23. The join part J is a welded and joined part that is formed, for example, by welding, such as ultrasonic welding, resistance welding, and laser welding, in a state that the plurality of positive electrode tabs 22t are overlaid. The welded and joined part is arranged with the plurality of positive electrode tabs 22t being gathered to one side in the short side direction X of the electrode body 20a, 20b, 20c. This can implement suitably bending the plurality of positive electrode tabs 22t so as to stably form the bent-shaped positive electrode tab group 23 as shown in FIG. 4.

The inclined part 52b is a portion that connects the down end of the electrical collector plate connecting part 52a to the top end of the tab join part 52c. The inclined part 52b is inclined with respect to the electrical collector plate connecting part 52a and the tab join part 52c. The inclined part 52b connects the electrical collector plate connecting part 52a to the tab join part 52c so as to position the electrical collector plate connecting part 52a closer to the center side more than the tab join part 52c in the long side direction Y. Thus, it is possible to expand the accommodation space of the electrode body group 20 so as to implement the high energy densification of the battery 100. It is preferable that the down end of the inclined part 52b (in other words, end part at the bottom wall 12a side of the outer package 12) positions downward more than the down end of the positive electrode tab group 23. This can implement suitably bending the plurality of positive electrode tabs 22t so as to stably form the bent-shaped positive electrode tab group 23 as shown in FIG. 4.

The negative electrode electrical collector part 60 configures a conduction passage that electrically connects the negative electrode tab group 25 and the negative electrode terminal 40, the negative electrode tab group 25 being consisted of the plurality of negative electrode tabs 241. As shown in FIG. 2, the negative electrode electrical collector part 60 includes a negative electrode first electrical collector part 61 that is arranged between the opening-seal plate 14 and the electrode body 20a, and includes a negative electrode second electrical collector part 62 to which the negative electrode tab group 25 is joined. The negative electrode first electrical collector part 61 is an example of the electrical collector part herein disclosed. The negative electrode first electrical collector part 61 and the negative electrode second electrical collector part 62 might be made from the same metal spices as the negative electrode electrical collector body 24c, for example, an electric conductive metal of copper, copper alloy, nickel, stainless steel, or the like. The configurations of the negative electrode first electrical collector part 61 and negative electrode second electrical collector part 62 might be similar to those of the positive electrode first electrical collector part 51 and positive electrode second electrical collector part 52 of the positive electrode electrical collector part 50.

As shown in FIG. 10, the negative electrode first electrical collector part 61 includes a first area 61a and a second area 61h. Between the opening-seal plate 14 and the first area 61a, a negative electrode insulation member 80 is arranged. The first area 61a is insulated from the opening-seal plate 14 by the negative electrode insulation member 80. In the first area 51a, at the position corresponding to the terminal taking out hole 19 of the opening-seal plate 14, a penetration hole 61h is formed that is penetrated in the vertical direction Z. As shown in FIG. 6, the negative electrode second electrical collector part 62 includes an electrical collector plate connecting part 62a that is electrically connected to the negative electrode first electrical collector part 61, an inclined part 62b, and a tab join part 62c that is attached to the negative electrode tab group 25 and electrically connected to the plurality of negative electrode tabs 241. The electrical collector plate connecting part 62a includes a recessed part 62d that is connected to the tab join part 62c. The recessed part 62d is provided with a penetration hole 62e that is penetrated in the short side direction X.

The positive electrode insulation member 70 is a member that establishes an insulation of the opening-seal plate 14 and the positive electrode first electrical collector part 51 inside the battery case 10. The positive electrode insulation member 70 is, for example, made of a resin material that has the resistance and electric insulating property to the used electrolyte and that is elastically deformable. It is preferable that the positive electrode insulation member 70 is, for example, made from a polyolefin resin, such as polypropylene (PP), a fluorinated resin, such as tetrafluoroethylene-perfluoroalkoxyethylene copolymer (PFA), a polyphenylene sulfide (PPS), or the like. As shown in FIG. 2, the positive electrode insulation member 70 includes a base part 70a and a protruding part 70b. The base part 70a and the protruding part 70b are here integrally formed.

The base part 70a is a portion arranged between the opening-seal plate 14 and the first area 51a of the positive electrode first electrical collector part 51 in the vertical direction Z. The base part 70a horizontally expands along the first area 51a of the positive electrode first electrical collector part 51. The base part 70a includes a penetration hole (not shown) that is penetrated in the vertical direction Z. The penetration hole is formed at a position corresponding to the terminal taking out hole 18 of the opening-seal plate 14.

The protruding part 70b each protrudes to the electrode body group 20 side more than the base part 70a. As shown in FIG. 10, the protruding part 70b is provided closer to the center side of the opening-seal plate 14 (right side in FIG. 10) more than the base part 70a in the long side direction Y. As shown in FIG. 3, the protruding part 70b here is opposed to the bent parts 20r of the electrode bodies 20a, 20b, 20c configuring the electrode body group 20.

As shown in FIG. 2, the negative electrode insulation member 80 is arranged in a symmetrical manner to the positive electrode insulation member 70 in the long side direction Y of the electrode body group 20. The particular configuration of the negative electrode insulation member 80 might be similar to the positive electrode insulation member 70. The negative electrode insulation member 80 here includes a base part 80a arranged between the opening-seal plate 14 and the negative electrode first electrical collector part 61, and includes a protruding part 80b, similarly to the positive electrode insulation member 70.

As shown in FIG. 5, the battery 100 in accordance with the present embodiment has the fixing member 1 be arranged in a Japanese Katakana “KO” letter shape so as to cover the positive electrode second electrical collector parts 52 included by the three electrode bodies 20a, 20h. 20c from a flat outer surface 27a to a flat outer surface 27f As described above, by using the fixing member 1 to fix the electrode bodies 20a, 20b, 20c, it is possible to suitably suppress the electrode body 20b from moving in the longitudinal direction. In addition, the fixing member 1 in accordance with the present embodiment is arranged to cover the three join parts 3 of the positive electrode first electrical collector part 51 and positive electrode second electrical collector part 52. As described above, by fixing the electrode body group 20 at a position closer to the opening-seal plate 14 of the positive electrode electrical collector part 50, it is possible to suitably suppress the electrode body group 20 from moving in the longitudinal direction.

As the fixing member 1, it is possible to preferably use a member including, for example, a base material and an adhesive layer formed on the base material. As one example of the above described base material, it is possible to obtain polyethylene (PE), polypropylene (PP), polyester, nylon, vinyl chloride, Teflon (registered trademark), polyimide, kapton (registered trademark), polyphenylene sulfide, polyethylene naphthalate, or the like. Although the thickness of the above described base material is not particularly restricted if the effects of the technique herein disclosed is implemented, it is approximately 5 μm to 100 μm, or can be preferably 10 μm to 50 μm. In addition, as one example of the material configuring the above described adhesive layer, it is possible to obtain an acrylic type adhesive agent, a silicon type adhesive agent, a rubber adhesive agent, or the like. It is preferable that the above described adhesive layer has an adhesive property at the room temperature (typically, about 20° C.). Although the thickness of the above described adhesive layer is not particularly restricted if the effects of the technique herein disclosed is implemented, it is approximately 5 μm to 100 μm, or can be preferably 5 μm to 20 μm.

As shown in FIG. 3, the battery 100 in accordance with the present embodiment is provided with insulation members 29 arranged between a long side wall opposed to the flat outer surface 27a among a pair of long side walls 12b (first side walls) and the flat outer surface 27a, and between the other long side wall among the pair of long side walls 12b and the flat outer surface 27f in the battery case 10. Then, the friction coefficients of the electrode bodies 20a, 20b, 20c (in other words, the friction coefficient of the flat outer surface 27b and flat outer surface 27c, and the friction coefficient of the flat outer surface 27d and flat outer surface 27e; below, they are referred to as friction coefficients A, too) are larger than the friction coefficient of the insulation member 29a and flat outer surface 27a, and the friction coefficient of the insulation member 29b and flat outer surface 27f (below, they are referred to as friction coefficients B, too), In accordance with such a configuration, the movement of the electrode body group 20 in the longitudinal direction is suppressed, and thus it is preferable. Here, as the above described friction coefficients A and B, it is possible to use a friction coefficient, for example, measured on the basis of the definition of JIS_K7125. In addition, the difference between the above described friction coefficients A and B can be about 0.1 to 0.9, or preferably about 0.5 to 0.8, which does not restrict the difference. Additionally, regarding the method for making the above described friction coefficients A and B have the difference as described above, it is possible to use a method that properly selects materials configuring the insulation member 29 and the flat outer surface 27. A person skilled in the art can perform a preliminary test, or the like, so as to easily select such materials.

Additionally, in the battery 100 according to the present embodiment, the friction coefficient of the electrode body 20a and electrode body 20b (in other words, the friction coefficient of the flat outer surface 27b and flat outer surface 27c) and the friction coefficient of the electrode body 20b and electrode body 20c (in other words, the friction coefficient of the flat outer surface 27d and flat outer surface 27e) (hereinafter, which might be referred to as friction coefficient C, too) are larger than the friction coefficient of the insulation member 29 and long side wall 12b (in other words, the friction coefficient of the insulation member 29a and long side wall 12b, and the friction coefficient of the insulation member 29b and long side wall 12b; hereinafter, which might be referred to as friction coefficient D, too). In accordance with such a configuration, the movement of the electrode body group 20 in the longitudinal direction is suppressed, and thus it is preferable, Here, as the above described friction coefficients C and D, it is possible to use friction coefficients, for example, measured on the basis of the definition of JIS_K7125, In addition, the difference between the above described friction coefficients C and D can be about 0.1 to 0.9, or preferably about 0.5 to 0.8, which does not restrict the difference. Additionally, regarding the method for making the above described friction coefficients C and D have the difference as described above, it is possible to use a method that properly selects materials configuring the insulation member 29, the long side wall 12b, and the flat outer surface 27. A person skilled in the art can perform a preliminary test, or the like, so as to easily select such materials.

As shown in FIG. 5, the battery 100 in accordance with the present embodiment includes the fixing member 1 that is neither arranged between the electrode body 20a and the electrode body 20b nor between the electrode body 20b and the electrode body 20c. In accordance with such a configuration, it is possible to make the integration thickness of the electrode body group 20 be small and thus possible to mitigate the pressure distribution provided to each of the electrode bodies configuring the electrode body group 20. Therefore, it is possible to suitably suppress the nonuniform reaction on each of the electrode bodies configuring the electrode body group 20, which is preferable.

<Manufacturing Method of Battery 100>

The manufacturing method of the battery 100 is characterized by including the fixing member 1 as described above. The other manufacturing processes might be similar to the conventional processes. The battery 100 can be manufactured by, in addition to the fixing member 1, preparing the above described battery case 10 (outer package 12 and opening-seal plate 14), the electrode body group 20 (electrode bodies 20a, 20b, 20c), the electrolyte, the positive electrode terminal 30, the negative electrode terminal 40, the positive electrode electrical collector part 50 (positive electrode first electrical collector part 51 and positive electrode second electrical collector part 52), the negative electrode electrical collector part 60 (negative electrode first electrical collector part 61 and negative electrode second electrical collector part 62), the positive electrode insulation member 70, and the negative electrode insulation member 80, and then by performing a manufacturing method including, for example, a first attaching step, a second attaching step, an insertion step, and a sealing step. In addition, the manufacturing method herein disclosed might further include another step at an arbitrary stage.

At the first attaching step, a first combined member as shown in FIG. 9 and FIG. 10 is manufactured. In particular, at first, the opening-seal plate 14 is attached with the positive electrode terminal 30, the positive electrode first electrical collector part 51, the positive electrode insulation member 70, the negative electrode terminal 40, the negative electrode first electrical collector part 61, and the negative electrode insulation member 80.

The positive electrode terminal 30, the positive electrode first electrical collector part 51, and the positive electrode insulation member 70 are fixed to the opening-seal plate 14, for example, by caulking process (riveting). As shown in FIG. 8, the caulking process is performed while the gasket 90 is sandwiched between the outside surface of the opening-seal plate 14 and the positive electrode terminal 30 and further the positive electrode insulation member 70 is sandwiched between the inner side surface of the opening-seal plate 14 and the positive electrode first electrical collector part 51. Additionally, the material of the gasket 90 might be similar to the positive electrode insulation member 70. For more details, the positive electrode terminal 30 before the caulking process is inserted into the penetration hole 90h of the gasket 90, the terminal taking out hole 18 of the opening-seal plate 14, the penetration hole 70h of the positive electrode insulation member 70, and then the penetration hole 5111 of the positive electrode first electrical collector part 51 in this order from the upward of the opening-seal plate 14, so as to be made to protrude to the downward of the opening-seal plate 14. Then, the portion of the positive electrode terminal 30 protruding downward more than the opening-seal plate 14 is caulked to add the compression force toward the vertical direction Z. Thus, a caulking part 30c is formed at the tip end part of the positive electrode terminal 30 (down end part in FIG. 2).

By the caulking process as described above, the gasket 90, the opening-seal plate 14, the positive electrode insulation member 70, and the positive electrode first electrical collector part 51 are integrally fixed to the opening-seal plate 14 and further the terminal taking out hole 18 is sealed. Additionally, the caulking part 30c might be welded and joined to the positive electrode first electrical collector part 51. Thus, it is possible to further improve the conduction reliability.

Fixing the negative electrode terminal 40, the negative electrode first electrical collector part 61, and the negative electrode insulation member 80 can be performed similarly to the above described positive electrode side, in other words, the negative electrode terminal 40 before the caulking process is inserted into the penetration hole of the gasket, the terminal taking out hole 19 of the opening-seal plate 14, the penetration hole of the negative electrode insulation member 80, and then the penetration hole of the negative electrode first electrical collector part 61 in this order from the upward of the opening-seal plate 14, so as to be made to protrude to the downward of the opening-seal plate 14. Then, the portion of the negative electrode terminal 40 protruding downward more than the opening-seal plate 14 is caulked to add the compression force toward the vertical direction Z. Thus, a caulking part 40c is formed at the Op end part of the negative electrode terminal 40 (down end part in FIG. 2).

Next, to the outside surface of the opening-seal plate 14, the positive electrode outside conductive member 32 and the negative electrode outside conductive member 42 are attached through the outside insulation member 92. Additionally, the material of the outside insulation member 92 might be similar to the positive electrode insulation member 70. In addition, the timing of attaching the positive electrode outside conductive member 32 and the negative electrode outside conductive member 42 might be after the insertion step (for example, after the liquid injection hole 15 is sealed).

At the second attaching step, the first combined member manufactured at the first attaching step is used to manufacture a second combined member as shown in FIG. 5. In other words, the electrode body group 20 integrated with the opening-seal plate 14 is manufactured. In particular, at first, as shown in FIG. 6, three electrode bodies 20a, each attached with the positive electrode second electrical collector part 52 and the negative electrode second electrical collector part 62, are prepared to be as the electrode bodies 20a, 20b, 20c, and are aligned in the short side direction X. At that time, the electrode bodies 20a, 20b, 20c might be arranged in parallel such that, in any of the electrode bodies, the positive electrode second electrical collector part 52 is arranged at one side (left side in FIG. 5) in the long side direction Y and the negative electrode second electrical collector part 62 is arranged at the other side (right side in FIG. 5) in the long side direction Y.

Next, in a state that the plurality of positive electrode tabs 22t are bent as shown in FIG. 4, the positive electrode first electrical collector part 51 (for more details, second area 51b) fixed to the opening-seal plate 14 and the positive electrode second electrical collector part 52 (for more details, electrical collector plate connecting part 52a) of the electrode body 20a, 20b, 20c are respectively joined. In addition, in a state that the plurality of negative electrode tabs 24t are bent, the negative electrode first electrical collector part 61 fixed to the opening-seal plate 14 and the negative electrode second electrical collector part 62 of the electrode body 20a, 20b, 20c are respectively joined. As the joining method, it is possible to use welding, for example, ultrasonic welding, resistance welding, laser welding, or the like. Particularly, it is preferable to use welding by irradiation of high energy ray, such as laser. By performing the welding process as described above, join parts are formed respectively on the recessed part 52d of the positive electrode second electrical collector part 52 and the recessed part 62d of the negative electrode second electrical collector part 62.

Next, as shown in FIG. 5, the fixing member 1 is arranged in a Japanese Katakana “KO” letter shape to cover the positive electrode second electrical collector parts 52 of the three electrode bodies 20a, 20b, 20c over the portion from the flat outer surface 27a to flat outer surface 27f Additionally, the timing of arranging the fixing member 1 might be before the positive electrode first electrical collector part 51 (for more details, second area Sib) fixed to the opening-seal plate 14 and the positive electrode second electrical collector part 52 (for more details, electrical collector plate connecting part 52a) of the electrode body 20a, 20b, 20c are respectively joined. In other words, according to the aspect shown in FIG. 6, the fixing member 1 might be arranged after the positive electrode tab group 23 is bent. Additionally, from the perspective of improving the operation efficiency, it is more preferable that the fixing member 1 is arranged at the previously described timing.

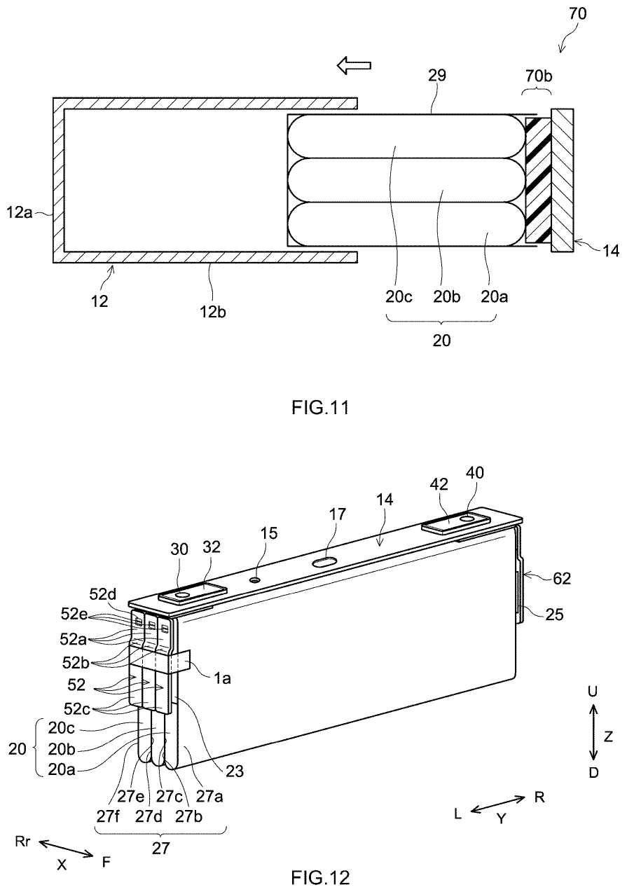

At the insertion step, the second combined member manufactured at the second attaching step is accommodated in the inside space of the outer package 12. FIG. 11 is a schematic cross sectional view that explains the insertion step. In particular, at first, a resin sheet (resin film) having an insulating property and being made of a resin material, for example, polyethylene (PE), or the like, is bent to be a bag-shape or a box-shape, so as to prepare the insulation member 29. Next, the electrode body group 20 is accommodated in the insulation member 29. Then, the electrode body group 20 covered by the insulation member 29 is inserted into the outer package 12. In the case where the weight of the electrode body group 20 is larger, the weight being approximately equal to or more than 1 kg, for example, equal to or more than 1.5 kg, or further 2 to 3 kg, it is preferable that arrangement is performed to make the long side wall 12b of the outer package 12 cross the gravity direction (arranging the outer package 12 in sideways) and then the electrode body group 20 is inserted into the outer package 12.

At the sealing step, the opening-seal plate 14 is joined to the edge part of the opening 12h of the outer package 12 so as to seal the opening 12h. The sealing step can be performed simultaneously with the insertion step or after the insertion step. At the sealing step, it is preferable that the outer package 12 and the opening-seal plate 14 are welded and joined. Welding and joining the outer package 12 and the opening-seal plate 14 can be performed, for example, by laser welding or the like. Then, the electrolyte is injected from the liquid injection hole 15 and then the liquid injection hole 15 is blocked by the sealing member 16, so as to seal the battery 100. As described above, it is possible to manufacture the battery 100.

Although the battery 100 can be used for various purposes, it is possible to suitably use the battery for a purpose in which external force, such as vibration and impact, is added at the use time, for example, can be used as the power source (power supply for drive) for a motor mounted on a movable body (vehicle of, typically, car, truck, or the like). Although the type of the vehicle is not particularly restricted, it is possible to consider, for example, plug-in hybrid vehicle (PHEV), hybrid vehicle (HEY), electric vehicle (BEV), or the like. It is possible to suitably use the battery 100 as a battery pack which is made by arranging a plurality of batteries 100 in a predetermined sequence direction and then by making a restrict mechanism add a load from the sequence direction.

Above, some embodiments of the present disclosure are explained, but the above described embodiments are merely examples. The present disclosure can be implemented in various other forms. The present disclosure can be executed based on the contents disclosed in the present specification, and the technical common sense in the present Field. The technique recited in the appended claims includes variously deformed or changed versions of the embodiments that have been illustrated above. For example, one part of the above described embodiment can be replaced with another deformed aspect, and furthermore another deformed aspect can be added to the above described embodiment. In addition, unless a technical feature is explained to be essential, this technical feature can be appropriately deleted.

In the above described embodiment, the electrode body 20a have the positive electrode tab group 23 and the negative electrode tab group 25 both be gathered at the flat outer surface 27a side and be joined (see FIG. 4), which does not restrict the present disclosure. For example, in the electrode body 20a, the positive electrode tab group 23 might be gathered at the flat outer surface 27a side and then joined, and the negative electrode tab group 25 might be gathered at the flat outer surface 27b side and then joined. Alternatively, the positive electrode tab group 23 (negative electrode tab group 25) might be separated for the flat outer surface 27a, side and for the flat outer surface 27h side, and then joined. The electrode bodies 20b, 20c might be similarly implemented.

In the above described embodiments, the bending number of the positive electrode tab group 23 and negative electrode tab group 25 is 1 in the electrode body 20a (see FIG. 4), which does not restrict the present disclosure. For example, it is possible to make the bending number be plural. The electrode bodies 20b, 20c might be similarly implemented.

Although the flat outer surface 27a of the electrode body 20a in the above described embodiment is arranged to have the length of the fixing member 1 in the Y direction be about 1/20 of length La of the flat outer surface 27a in the Y direction (see FIG. 5), which does not restrict the present disclosure. For example, the length of the fixing member in the Y direction can be approximately equal to or more than ( 1/30) La, and from the perspective of improving the fixing strength, can be preferably equal to or more than ( 1/20) La, more preferably equal to or more than ( 1/10) La, or furthermore preferably equal to or more than (⅕) La. In addition, the length of the fixing member in the Y direction might be La, and can be equal to or less than (¾) La, equal to or less than (½) La, or equal to or less than (⅓) La. The length of the fixing member 1 in the Y direction, which is arranged on the flat outer surface 27f, might be similarly implemented.

The above described embodiment is explained about an aspect in which the fixing member 1 is arranged in a Japanese Katakana “KO” letter shape to cover the positive electrode second electrical collector part 52 including three electrode bodies 20a, 20b, 20c over the portion from the flat outer surface 27a to the flat outer surface 27f, which does not restrict the present disclosure. For example, the fixing member might be arranged in a. Japanese Katakana “KO” letter shape to cover the negative electrode second electrical collector part 62 including three electrode bodies 20a, 20b, 20c at a portion from the flat outer surface 27a to the flat outer surface 27f. Additionally, in the case where the case where the fixing member is arranged at the negative electrode side in a Japanese Katakana “KO” letter shape (in other words, the arrangement aspect described later), compared to the case where the fixing member is arranged at the positive electrode side in a Japanese Katakana letter shape (in other words, the previously described arrangement aspect), fixing the electrode bodies at the negative electrode side can suitably inhibit buckling of the positive electrode tab group considered to easily buckle and extend, which is preferable. In addition, for example, the fixing member might be arranged over the portion from the flat outer surface 27a of the electrode body 20a to the positive electrode second electrical collector part 52 of the electrode body 20a and to the positive electrode second electrical collector part 52 of the electrode body 20b, and might be arranged over the portion from the flat outer surface 27f of the electrode body 20c to the negative electrode second electrical collector part 62 of the electrode body 20c and to the negative electrode electrical collector part 62 of the electrode body 20b. Additionally, these are examples and thus it is possible to implement the present disclosure in various different forms.

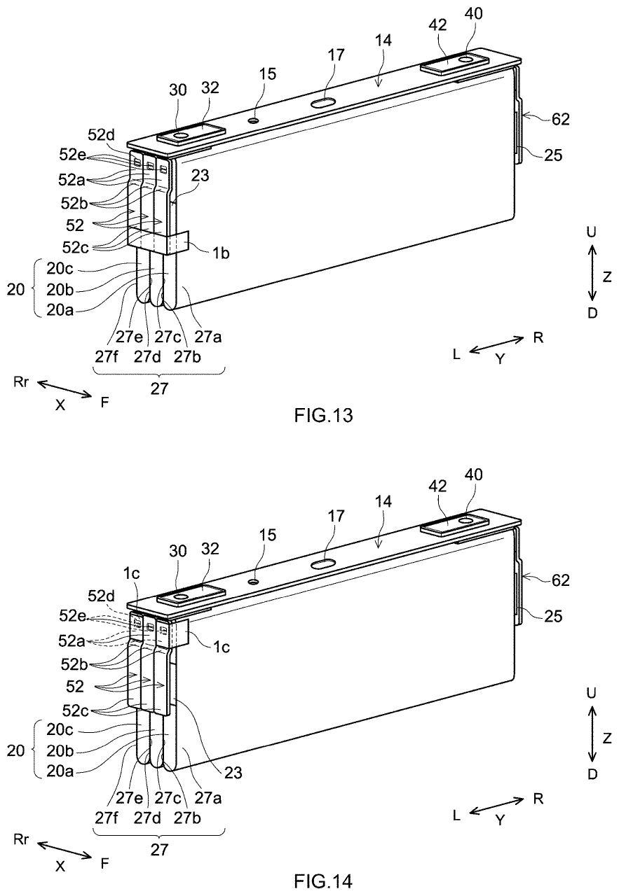

In the above described embodiment, an aspect is explained in which the fixing member 1 is arranged to cover three join parts of the positive electrode first electrical collector part 51 and positive electrode second electrical collector part 52, which does not restrict the present disclosure. For example, as shown in FIG. 12, the fixing member 1a might be arranged in a Japanese Katakana “KO” letter shape to cover the vicinity of center portion of the positive electrode second electrical collector parts 52 included by three electrode bodies 20a, 20b, 20c. In addition, for example, as shown in FIG. 13, the fixing member 1b might be arranged in a Japanese Katakana “KO” letter shape to cover the downward of the positive electrode second electrical collector parts 52 included by three electrode bodies 20a, 20b, 20c. Furthermore, it is possible to appropriately combine the aspects of FIG. 5, FIG. 12, and FIG. 13 to implement the present disclosure. Additionally, in the case where the fixing member is arranged as shown in FIG. 12 and FIG. 13, it is preferable not to cover the tab join part 52c. In addition, the above descriptions explain while focusing on the positive electrode second electrical collector part 52, but of course, the negative electrode second electrical collector part 62 might be similarly implemented. Additionally, these are examples and thus it is possible to implement the present disclosure in various different forms.

In the above described embodiment, it explains about the aspect in which the fixing member 1 is arranged even on the positive electrode second electrical collector part 52 of the electrode body 20b, which does not restrict the present disclosure. Fax example, as shown in FIG. 14, the fixing member 1c might be arranged at a portion from the flat outer surface 27a of the electrode body 20a to the positive electrode second electrical collector part 52 of the electrode body 20a and might be arranged at a portion from the flat outer surface 27f of the electrode body 20c to the positive electrode second electrical collector part 52 of the electrode body 20c. In this case, the frictions generated between the flat outer surface 27b and the flat outer surface 27c and between the flat outer surface 27d and the flat outer surface 27e suppress the electrode body 20b from moving in the longitudinal direction, which is preferable.

Alternatively, in the case where the flat outer surface is configured with the separator 26 as if the electrode bodies 20a, 20b, 20c in accordance with the present embodiment is (see FIG. 7), adhesive layers might be provided on the flat outer surfaces (in other words, the outermost surface of the separator) of the electrode bodies 20a, 20b, 20c in order to suppress the electrode body 20b from moving in the longitudinal direction. As one example of the above described adhesive layer, it is possible to use a layer containing PVdF. In addition, the above described adhesive layer might contain other components, such as inorganic filler. As one example of the above described inorganic filler, it is possible to use alumina, boehmite, aluminum hydroxide, titania, or the like, Here, in the case where the whole component configuring the above described adhesive layer is treated as 100 mass %, the content amount of PVdF can be approximately equal to or more than 5 mass %, and can be preferably equal to or more than 10 mass %, more preferably equal to or more than 15 mass %, or furthermore preferably equal to or more than 20 mass %. In addition, the content amount of PVdF might be 100 mass %, and can be, for example, equal to or less than 90 mass %, or preferably equal to or less than 80 mass %.

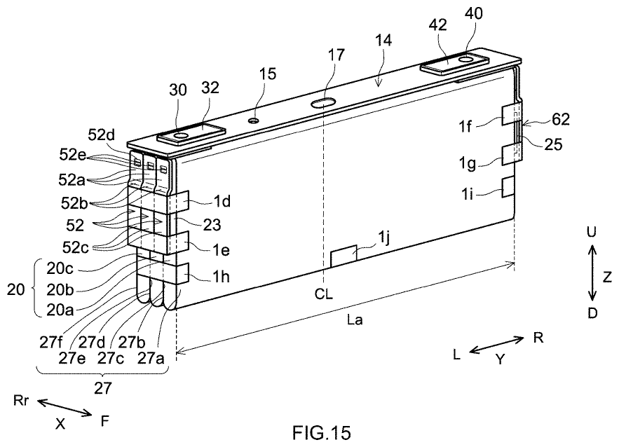

In addition, as a suitable embodiment, it is possible to use an arranging method of the fixing member as shown in FIG. 15. In FIG. 15, the fixing members 1d, 1e are respectively arranged at a portion from the flat outer surface 27a to the flat outer surface 27f to cover the vicinity of the center and the downward of the positive electrode second electrical collector parts 52 of the three electrode bodies 20a, 20b, 20c. In addition, the fixing members 1f, 1g are respectively arranged over the portion from the flat outer surface 27a to the flat outer surface 27f to cover the vicinity of the center and the downward of the negative electrode second electrical collector parts 62 of the three electrode bodies 20a, 20b, 20c. Then, furthermore, auxiliary fixing members 1h, 1i, 1j are arranged at a portion from the flat outer surface 27a to the flat outer surface 27f in a Japanese Katakana “KO” letter shape, the portion where neither the positive electrode second electrical collector part 52 nor the negative electrode second electrical collector part 62 exists. Thus, it is possible to suitably suppress the electrode body 20b from moving in the longitudinal direction. Additionally, in FIG. 15, the fixing members 1d, 1e, 1h and the fixing members 1f, 1g, 1i are arranged in a symmetrical manner with respect to the center line CL passing the center part in the Y direction of the battery case 10, which does not restrict the present disclosure, and might be arranged in an asymmetrical manner with respect to the CL. Additionally, in FIG. 15, the auxiliary fixing member 1j is arranged at the center part of La, which does not restrict the present disclosure, and might be arranged at a position appropriately shifted in the left and right (left and right in FIG. 15) direction. As shown in FIG. 15, from the perspective of effectively suppressing the electrode body 20b from moving in the longitudinal direction, it is preferable that all the auxiliary fixing members 1h, 1i, 1i are arranged, but it is possible to appropriately reduce the number of them. Then, although not shown in FIG. 15, it is also possible to arrange the fixing member in a Japanese Katakana “KO” letter shape over the portion from the flat outer surface 27a to the flat outer surface 27f so as to cover the opening-seal plate 14.

In the above described embodiment, it explains about the battery 100 including three electrode bodies, which does not restrict the present disclosure. For example, a plurality of (in other words, 2 or more) electrode bodies are arranged between the electrode body 20a and the electrode body 20c. In this case, it is preferable that the electrode body 20a, the plurality of electrode bodies arranged between the electrode body 20a and the electrode body 20c, and the electrode body 20c are fixed. As one example for the fixing method of such electrode bodies to each other, it is possible to use a method of arranging the fixing members at a portion from the flat outer surface 27a to the flat outer surface 27f in a Japanese Katakana “KO” letter shape so as to cover the positive electrode second electrical collector part and/or negative electrode second electrical collector part of each electrode body. In addition, an adhesive layer as described above might be provided to the flat outer surface of each electrode body. This can suitably suppress each electrode body from moving in the longitudinal direction.

In the above described embodiment, it explains about the battery 100 including three electrode bodies, which does not restrict the present disclosure. For example, the battery might include only one electrode body. For example, in the case where the battery includes the electrode body 20a, the fixing member can be arranged at a portion from the flat outer surface 27a to the positive electrode second electrical collector part 52 in a L letter shape. Alternatively, the fixing member can be arranged at a portion from the flat outer surface 27a to the flat outer surface 27h in a Japanese Katakana “KO” letter shape. Here, when the fixing member is arranged in a state of keeping the tension, such as in a Japanese Katakana “KO” letter shape, the electrode body 20a is firmly fixed to the positive electrode second electrical collector part 52, which is preferable. In addition, the above descriptions explain about the positive electrode second electrical collector part 52, but of course, the negative electrode second electrical collector part 62 might be similarly implemented. Additionally, these are examples and thus it is possible to implement the present disclosure in various different forms.

What is claimed is:

1. A battery comprising:
a first electrode body with a positive electrode and a negative electrode, and that is formed in a flat hexahedron shape having a pair of rectangular-shaped flat outer surfaces; and
a battery case that accommodates the first electrode body,
wherein the battery case comprises:
an outer package that has a bottom wall, a pair of first side walls extending from the bottom wall and opposed to each other, a pair of second side walls extending from the bottom wall and opposed to each other, and an opening opposed to the bottom wall; and
an opening-seal plate for sealing the opening,
a positive electrode terminal and a negative electrode terminal are attached to the opening-seal plate,
a positive electrode tab group comprising a plurality of positive electrode tabs is arranged at a side of one second side wall among the pair of second side walls,
a negative electrode tab group comprising a plurality of negative electrode tabs is arranged at a side of another second side wall among the pair of second side walls,
the positive electrode tab group and the positive electrode terminal are electrically connected through a positive electrode electrical collector part, the positive electrode tab group is joined to the positive electrode electrical collector part in a state that the positive electrode tab group is bent to extend along the second side wall,
the negative electrode tab group and the negative electrode terminal are electrically connected through a negative electrode electrical collector part, the negative electrode tab group is joined to the negative electrode electrical collector part in a state that the negative electrode tab group is bent to extend along the second side wall, and
here, a fixing member is arranged at a portion at least from one flat outer surface among the pair of flat outer surfaces to the positive electrode electrical collector part or the negative electrode electrical collector part.

2. The battery according to claim 1,
wherein the positive electrode tab group is joined to a surface at a side of the first electrode body in the positive electrode electrical collector part, and
the negative electrode tab group is joined to a surface at a side of the first electrode body in the negative electrode electrical collector part.

3. The battery according to claim 1,
wherein the positive electrode tab group is joined to the positive electrode electrical collector part in a state that the positive electrode tab group is gathered to a side of one flat outer surface among the pair of flat outer surfaces, and
the negative electrode tab group is joined to the negative electrode electrical collector part in a state that the negative electrode tab group is gathered to a side of one flat outer surface among the pair of flat outer surfaces.

4. The battery according to claim 1,
wherein the fixing member covers neither a join part of the positive electrode tab group and the positive electrode electrical collector part nor a join part of the negative electrode tab group and the negative electrode electrical collector part.

5. The battery according to claim 1,
wherein the positive electrode tab is configured with an aluminum or an aluminum alloy foil,
the negative electrode tab is configured with a copper or a copper alloy foil, and
here, the fixing member is arranged at a portion at least from one flat outer surface among the pair of flat outer surfaces to the negative electrode electrical collector part but arranged at a portion from neither flat outer surface among the pair of flat outer surface to the positive electrode electrical collector part.

6. The battery according to claim 1,
wherein the positive electrode electrical collector part comprises a positive electrode first electrical collector part arranged between the opening-seal plate and the first electrode body, and a positive electrode second electrical collector part joined to the positive electrode tab group,
the negative electrode electrical collector part comprises a negative electrode first electrical collector part arranged between the opening-seal plate and the first electrode body, and a negative electrode second electrical collector part joined to the negative electrode tab group, and
here, the fixing member covers at least a join part of the positive electrode first electrical collector part and the positive electrode second electrical collector part, or a join part of the negative electrode first electrical collector part and the negative electrode second electrical collector part.

7. The battery according to claim 1,
wherein the pair of flat outer surfaces each is configured with a separator, and
a layer containing poly vinylidene fluoride is formed at the outermost surface of the separator.

8. The battery according to claim 1,
wherein a second electrode body whose configuration is the same as the first electrode body is further arranged in the battery case.

9. The battery according to claim 8,
wherein further one or a plurality of electrode bodies whose configurations are the same as the first electrode body are arranged between the first electrode body and the second electrode body.

10. The battery according to claim 9,
wherein the first electrode body, an electrode body arranged between the first electrode body and the second electrode body, and the second electrode body are fixed.

11. The battery according to claim 9,
wherein it is not satisfied that the fixing member of the first electrode body and the fixing member of the second electrode body are arranged at any portion between the first electrode body, an electrode body arranged between the first electrode body and the second electrode body, and the second electrode body.

12. The battery according to claim 9,
wherein an auxiliary fixing member is further arranged at a portion from a flat outer surface opposed to the first side wall among the pair of flat outer surfaces of the first electrode body to a flat outer surface opposed to the first side wall among the pair of flat outer surfaces of the second electrode body, and
here, the auxiliary fixing member is arranged at a portion other than the positive electrode electrical collector parts and the negative electrode electrical collector parts included by the first electrode body, an electrode body arranged between the first electrode body and the second electrode body, and the second electrode body.

13. The battery according to claim 9,
wherein insulation members are arranged between the first side wall opposed to the flat outer surface of the first electrode body among the pair of first side walls and the flat outer surface of the first electrode body, and between another first side wall among the pair of first side walls and the flat outer surface of the second electrode body in the battery case, and
here, friction coefficients of the first electrode body, of an electrode body arranged between the first electrode body and the second electrode body, and of the second electrode body are larger than a friction coefficient of the insulation member and the flat outer surface of the first electrode body, and than a friction coefficient of the insulation member and the flat outer surface of the second electrode body.

14. The battery according to claim 13,
wherein the insulation member is configured with a resin film, and
friction coefficients of the first electrode body, of an electrode body arranged between the first electrode body and the second electrode body, and of the second electrode body are larger than a friction coefficient of the insulation member and the first side wall.
